(19) United States
(12) Patent Application Publication
(10) Pub. No.: US 2026/0010710 A1
(43) Pub. Date: Jan. 8, 2026

(54) DOCUMENT MANAGEMENT METHOD, DOCUMENT MANAGEMENT SYSTEM, REVISION SUGGESTION METHOD, AND REVISION SUGGESTION SYSTEM

(71) Applicant: LEGALON TECHNOLOGIES, INC., Tokyo (JP)

(72) Inventors: Akihiko MATSUBA, Tokyo (JP); Takahiko Kai, Tokyo (JP); Takakazu Yanaka, Tokyo (JP); Taizo Yamada, Tokyo (JP)

(73) Assignee: LEGALON TECHNOLOGIES, INC., Tokyo (JP)

(21) Appl. No.: 19/329,955

(22) Filed: Sep. 16, 2025

Related U.S. Application Data
(63) Continuation of application No. PCT/JP2023/010622, filed on Mar. 17, 2023.

(51) Int. Cl. G06F 40/197

(52) U.S. Cl. CPC G06F 40/197

(57) ABSTRACT

A document management method executed by a processor includes: acquiring an electronic document including revision history information regarding a revision history; generating at least one old version document that is an old version of the electronic document according to a revision step corresponding to the revision history based on the electronic document and the revision history information; and storing the at least one old version document in a memory in association with version information regarding a document version in the revision step corresponding to the at least one old version document.

### CROSS-REFERENCE TO RELATED APPLICATION

The present application is a bypass continuation application based on and claims the benefit of priority from PCT Application No. PCT/JP2023/010622 filed on Mar. 17, 2023, the entire contents of which are incorporated herein by reference.

### TECHNICAL FIELD

The present disclosure relates to a document management method, a document management system, a non-transitory computer-readable medium storing a document management program, a revision proposal method, a revision proposal system, and a non-transitory computer-readable medium storing a revision proposal program.

### BACKGROUND ART

Conventionally, there have been known techniques for generating a document in the past and techniques for proposing revisions to a document based on the revision history of a document.

For example, the document creation support apparatus described in Japanese Patent Laid-Open No. 2010-92227 (Patent Literature 1) generates template contract document divided data and revised contract document divided data obtained by dividing template contract document data and revised contract document data for each article. Then, based on the template contract document divided data and the revised contract document divided data, the document creation support apparatus generates comparison data indicating correspondence between both contract documents for each article and different parts between the corresponding articles. Further, the document creation support apparatus extracts examination item data related to the difference parts from among examination item data specified for each article of the template contract document based on the comparison data, and generates output data based on the comparison data and the extracted examination item data.

### SUMMARY

A document management method according to an aspect of the present invention is a document management method executed by a processor, and includes: acquiring an electronic document including revision history information regarding a revision history; generating at least one old version document that i s an old version of the electronic document according to a revision step corresponding to the revision history based on the electronic document and the revision history information; and storing the at least one old version document in a memory in association with version information regarding a document version in the revision step corresponding to the at least one old version document.

### BRIEF DESCRIPTION OF DRAWINGS

FIG. 1 is a diagram showing an overview of processing in a revision proposal system 10 and a document management system 100 that are an embodiment of the present invention.

FIG. 2 is a diagram showing a configuration of the revision proposal system 10 and the document management system 100 that are an embodiment of the present invention.

FIG. 3 is a diagram showing an example of history document information stored in a storage unit 110.

FIG. 4 is a diagram showing an example of revision history information stored in the storage unit 110.

FIG. 5 is a diagram showing an example of classification information stored in the storage unit 110.

FIG. 6 is a diagram showing an example of old version document information stored in the storage unit 110.

FIG. 7 is a diagram showing an example of revision steps of an electronic document and at least one old version document displayed on a user terminal 200.

FIG. 8 is a diagram showing an example of target document information stored in a storage unit 135.

FIG. 9 is a diagram showing an example of item information stored in the storage unit 135.

FIG. 10A is a diagram showing an example of revision steps in a history document.

FIG. 10B is a diagram showing an example of correspondence information stored in the storage unit 135.

FIG. 11 is a diagram showing an example of provision of revision proposal information by a revision proposal unit 165.

FIG. 12 is a diagram showing an example of provision of revision proposal information by the revision proposal unit 165.

FIG. 13 is a flowchart showing an example of processing in the document management system 100.

FIG. 14 is a flowchart showing an example of processing in the revision proposal system 10.

FIG. 15 is a diagram showing an example of a hardware configuration of a computer 1500.

### DESCRIPTION

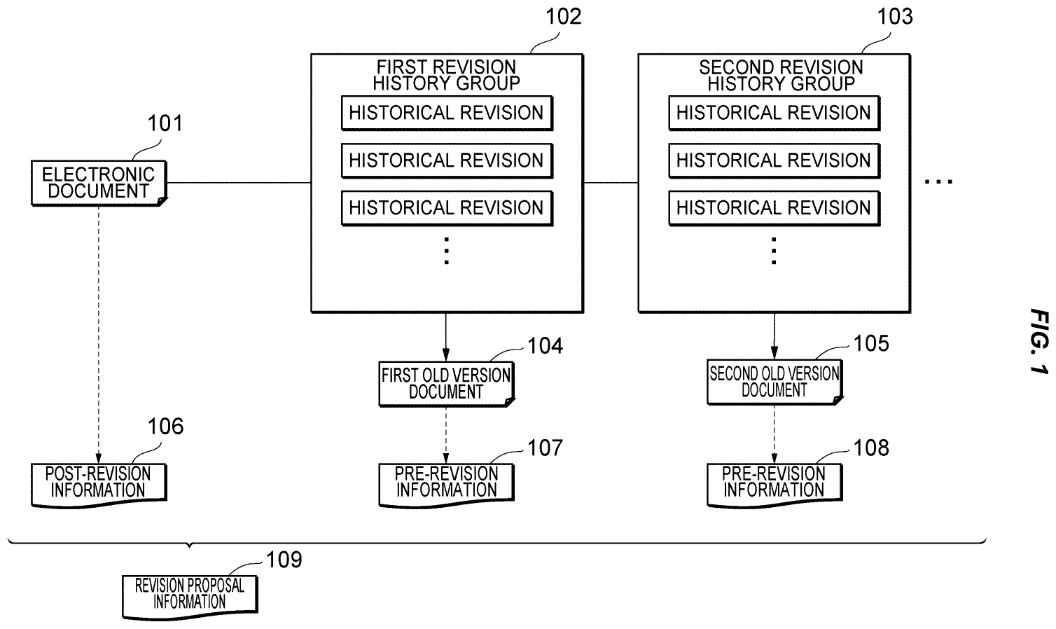

An embodiment of the present invention will be described with reference to the accompanying drawings. FIG. 1 is a diagram showing an overview of processing in a revision proposal system 10 and a document management system 100 that are an embodiment of the present invention.

According to an embodiment of the present invention, it is possible to provide a document management method enabling document management or revision proposal in an electronic document including a revision history.

The document creation support apparatus described in Patent Literature 1 does not consider processing in a document including revision history information regarding a revision history.

Therefore, an embodiment of the present invention aims to provide a document management method, a document management system, a non-transitory computer-readable medium storing a document management program, a revision proposal method, a revision proposal system, and a non-transitory computer-readable medium storing a revision proposal program enabling document management or revision proposal in an electronic document including a revision history.

An electronic document may be revised as necessary and completed. For example, when the electronic document is a business report, it may be drafted by a person in charge of business and then revised by a business manager (e.g., a person in a higher position than the person in charge of business), and as a result the business report may be fixed.

Further, for example, if the electronic document is a contract document, when an agreement between the contracting parties is made, one or both of the contracting parties may inspect and revise the contract document. As an example, in the case of a contract between companies, for example, the legal department in charge of contract inspection may inspect the content of a contract document and revises it as necessary. Note that the inspection of a contract document may also be referred to as confirmation, examination, or review.

Such revision of an electronic document may be performed using a revision history recording function provided in an editing application for electronic documents. For example, in a case where the electronic document is a contract document, when one or both of the contracting parties may inspect and revise the contract document, for example, one or both of the contracting parties may revise the contract document while recording the revision history in an editing application.

However, an electronic document including revision history information regarding a revision history may be one electronic document file, in which case it may be a trouble for a user to refer to the revision history (i.e., the version of the document). Further, when it is saved as a separate file for each revision step (i.e., when the document is saved for each version), it may be a trouble for the user. In particular, when the electronic document is a contract document, it may be necessary to manage the versions according to the reviews made by the contracting parties, so when the automatic save function provided in an editing application is used, it may be a trouble for the user to refer to the revision history.

Therefore, the document management system 100 of this embodiment may generate an old version document that is an old version of an electronic document according to a revision step.

Specifically, the document management system 100 may be an information processing system implemented by a document management program, generates an old version document that is an old version of an electronic document according to a revision step corresponding to a revision history based on revision history information regarding the revision history, and store the old version document in a memory in association with version information regarding a document version in the revision step corresponding to the old version document. More specifically, the document management system 100 may classify the revision history information into groups according to revision steps, generate an old version document that is an old version of the electronic document for each group according to the revision step corresponding to the group, and store the old version document in a memory in association with version information.

Further, an electronic document may be revised with reference to revision histories of similar electronic documents in the past. For example, when the electronic document is a contract document, inspection and revision of the contract document by one or both of the contracting parties may be performed, for example, based on past revision cases or contract cases.

Therefore, the revision proposal system 10 of this embodiment may propose a revision to a target document different from an electronic document based on the electronic document and an old version document that is an old version of the electronic document.

Specifically, the revision proposal system 10 may be an information processing system implemented by a revision proposal program, and provide revision proposal information regarding proposal of a revision to a target item in a target document based on post-revision information that indicates content of an item of an electronic document including revision history information and that is stored in a memory in association with pre-revision information of an old version document generated based on the revision history information according to a revision step in which the pre-revision information is revised.

Note that each of the revision proposal system 10 and the document management system 100 may be an independent information processing system, and the document management system 100 may be an information processing system incorporated in the revision proposal system 10. In the following description of this embodiment, the document management system 100 will be described as an information processing system incorporated in the revision proposal system 10.

First, the document management system 100 may acquire an electronic document (an electronic document 101) including revision history information, and classify the revision history information into at least one group (a first revision history group 102 and a second revision history group 103) corresponding to a revision step. Subsequently, the document management system 100 may generate an old version document (a first old version document 104 and a second old version document 105) for each group according to the revision step corresponding to the group, and store the old version document in a memory in association with version information.

Next, the revision proposal system 10 may generate post-revision information 106 indicating the content of items of the electronic document 101 and pre-revision information (pre-revision information 107 and pre-revision information 108) indicating the content of the items of the old version document, and store the pre-revision information and the post-revision information in a memory in association with each other. Then, the revision proposal system 10 may provide revision proposal information 109 regarding proposal of a revision to a target item in a target document different from the electronic document 101 based on the post-revision information.

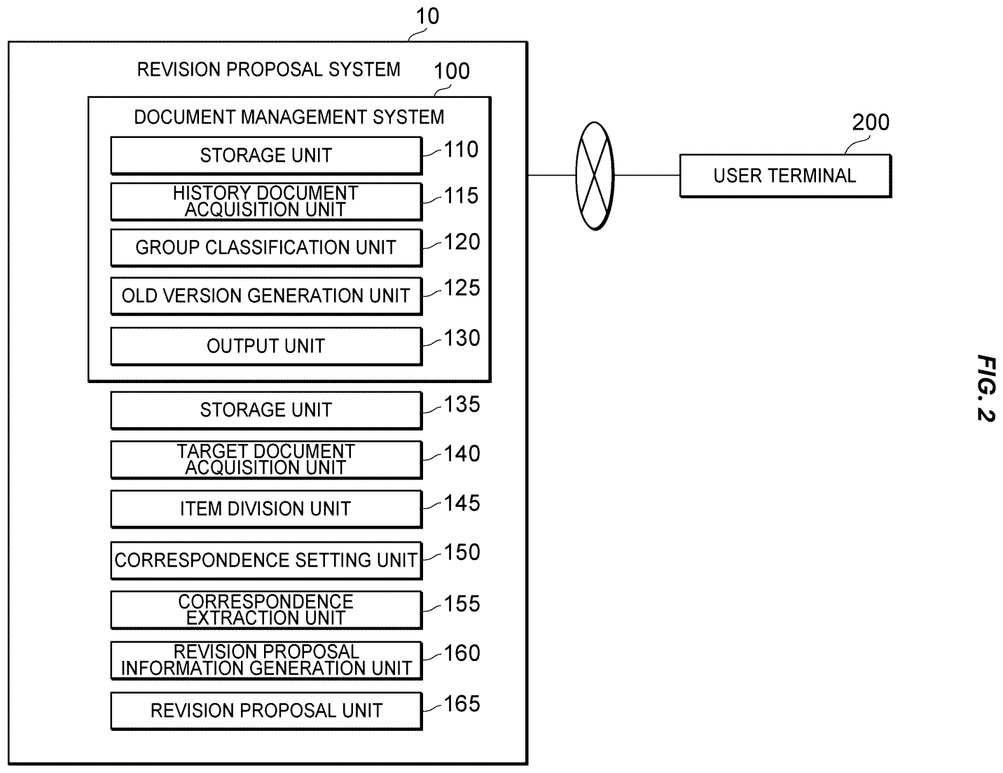

FIG. 2 is a diagram showing a configuration of the revision proposal system 10 and the document management system 100 that are an embodiment of the present invention. Note that FIG. 2 shows the document management system 100 as an information processing system incorporated in the revision proposal system 10, but each of the revision proposal system 10 and the document management system 100 may be an independent information processing system.

The revision proposal system 10 and the document management system 100 may be communicatively connected to a user terminal 200 via a network such as the Internet. Details of the revision proposal system 10 will be described later.

The user terminal 200 may be, for example, a computer used by a user of the revision proposal system 10, such as a smartphone, a tablet terminal, a personal computer, or the like.

For example, the user may access the document management system 100 through the user terminal 200 and upload an electronic document including revision history information to the document management system 100. Further, the user may upload a target document to the revision proposal system 10 through the user terminal 200. Then, the user may be provided with revision proposal information for a target item in the target document through the user terminal 200.

Note that only one user terminal 200 is shown in FIG. 2, but the number of user terminals 200 is not limited thereto. Further, one user terminal 200 may be used by a plurality of users.

Subsequently, details of the revision proposal system 10 and the document management system 100 will be described.

The document management system 100 of this embodiment may include a storage unit 110, a history document acquisition unit 115, a group classification unit 120, an old version generation unit 125, and an output unit 130.

The revision proposal system 10 of this embodiment may include the document management system 100, and further include a storage unit 135, a target document acquisition unit 140, an item division unit 145, a correspondence setting unit 150, a correspondence extraction unit 155, a revision proposal information generation unit 160, and a revision proposal unit 165.

Note that each unit shown in FIG. 2 can be implemented, for example, by using a storage area or by a processor executing a program stored in the storage area.

The storage unit 110 of this embodiment may store information processed in the document management system 100. The storage unit 110 can store, for example, history document information, classification information, and old version document information, which will be described later. The storage unit 110 may be, for example, a memory.

The history document acquisition unit 115 of this embodiment may acquire a history document that is an electronic document including revision history information regarding a revision history, and store history document information regarding the history document in the storage unit 110.

Here, the history document may be, for example, an electronic document of a contract document. A contract document may be, for example, an electronic document created by predetermined electronic document creation software, or an electronic document obtained by digitizing a paper contract document using a predetermined image analysis technique (e.g., OCR (Optical Character Recognition) technology). Contract documents to be processed by the document management system 100 and the revision proposal system 10 may be, for example, documents that include clauses and generate predetermined legal effects, and include application forms, memorandums, and the like.

Contract documents may include not only a contract document agreed upon by both parties, but also a contract document being confirmed by both parties (i.e., a draft of the contract document), a contract document that has been exchanged between the parties but has not reached an agreement, or contract document templates created for reference when contracting with others. In the description=related to this embodiment, unless otherwise specified, “contract documents” include not only a contract document agreed upon by both parties, but also a contract document being confirmed by both parties (i.e., a draft of the contract document), a contract document that has been exchanged between the parties but has not reached an agreement, or contract document templates created for reference when contracting with others.

Further, in this embodiment, the history document (i.e., an electronic document including revision history information) may be a fixed history document or the latest history document, or may be a history document that is not the latest version. A case where the history document is a history document that is not the latest version is, for example, a case where there are a series of history documents of the first version, the second version, and the latest version and the history document acquisition unit 115 may acquire the second version of the history document. This enables the document management system 100 (in particular, the old version generation unit 125 described later) to generate an old version document (in this case, the first version) described later based on the second version of the history document without requiring the latest version of the history document.

The revision history information may be information about a history in which an electronic document is revised. The revision history information may include, for example, at least one of revision user information indicating a revision user who made a revision and revision date information indicating a date on which a revision was made.

Here, a revision may be an editing operation on an electronic document, and it may include, for example, replacing or deleting characters written in the electronic document, adding new characters, applying a predetermined effect to characters (e.g., changing the layout or format, more specifically, for example, changing the font, changing to italics, underlining, highlighting, and adding or removing indentation), inserting a figure or a table, and adding a comment using a comment function. Thus, the revision history information may include information about the revision history described above.

An revision user may be a subject who revises a history document using a predetermined application. The revision user may be a user of the document management system 100 and may not be a user of the document management system 100. For example, it may be a user name in an application that edits a document whose information is saved in a document file. Further, the revision user may be a natural person, or may be a computer (e.g., a computer that performs automatic revision using natural language processing technology).

By referring to the history document using the predetermined application, the revision user can refer to the content of a revision made by a predetermined revision user on a predetermined date based on the revision history information. Further, the revision user can refer to the content after the revision and refer to the content before the revision.

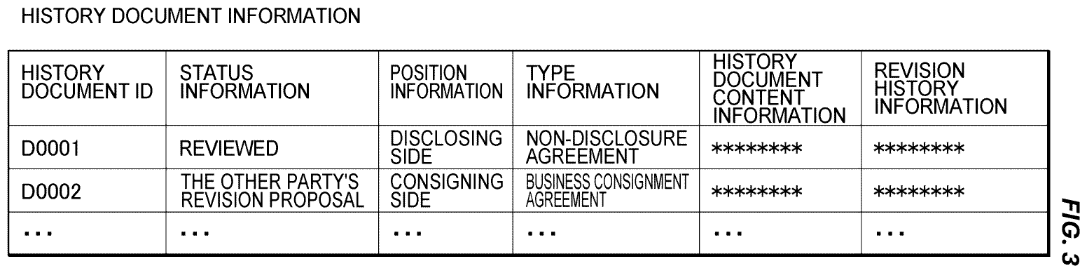

FIG. 3 is a diagram showing an example of history document information stored in the storage unit 110. The history document information stored in the storage unit 110 may include, for example, a history document ID, status information, position information, type information, history document content information, and revision history information.

The history document ID of this embodiment may be information identifying history document information stored in the storage unit 110.

The status information of this embodiment may be information indicating the status of an electronic document, and information indicating the revision status of the electronic document. When the electronic document is a contract document, the status information may be one of, for example, “the other party's draft” indicating that it is a draft (e.g., the first draft) of the counterparty to the contract, “the other party's revision proposal” indicating that it is a contract document revised by the counterparty to the contract, “reviewed” indicating that it is a contract document that has been confirmed (reviewed) by one's own company (e.g., the business to which the user belongs), or “concluded” indicating that the agreement between the contracting parties has been completed.

The position information of this embodiment may be information indicating the position of an electronic document, and may be, for example, information indicating the position of one's own company (the business to which the user belongs). When the electronic document is a contract document, the position information may be, for example, “consigning side” indicating that it is the consignor side in a business consignment agreement, or “disclosing side” indicating the disclosing side of confidential information in a non-disclosure agreement.

The type information of this embodiment may be information indicating the type of an electronic document. When the electronic document is a contract document, the type information may be information indicating the contract type of the contract document, and include, for example, a “business consignment agreement” or a “non-disclosure agreement”.

The history document content information of this embodiment may be information (e.g., character data) indicating the content of a history document.

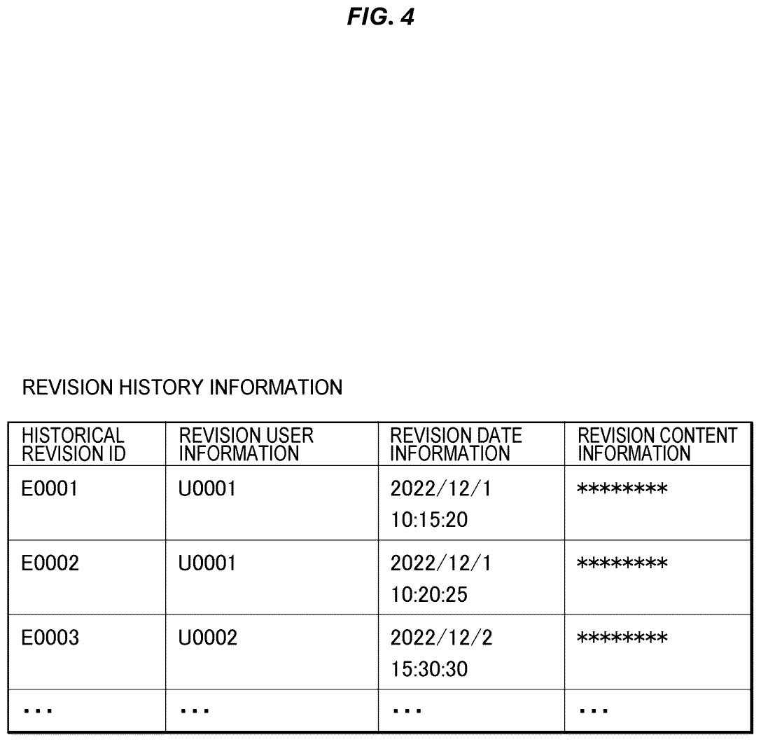

FIG. 4 is a diagram showing an example of revision history information stored in the storage unit 110. The revision history information stored in the storage unit 110 may include, for example, a historical revision ID, revision user information, revision date information, and revision content information.

The historical revision ID of this embodiment may be information identifying revision history information stored in the storage unit 110. The revision content information of this embodiment may be information indicating the content of a revision, and may include, for example, information indicating a revision part and information indicating a revision operation (e.g., addition, replacement or deletion of characters).

The history document acquisition unit 115 may acquire history document information from the user terminal 200, for example. That is, the user may provide (upload) a history document to the document management system 100 through the user terminal 200, and the history document acquisition unit 115 may acquire the history document information regarding the uploaded history document.

At this time, the history document acquisition unit 115 may acquire the history document information from the user through the operation of the user terminal 200, for example. In this case, for example, when receiving an upload of the history document from the user terminal 200, the history document acquisition unit 115 may receive input (e.g., input by keyboard, or selection of items preset in the document management system 100) of at least some of the history document information (e.g., status information, position information, or type information) from the user to acquire the history document information.

The group classification unit 120 of this embodiment may classify the revision history information into at least one group corresponding to a revision step, and store classification information indicating the result of the classification in the storage unit 110.

The group classification unit 120 can classify the revision history information into at least one group corresponding to the revision step based on at least one of the revision user information and the revision date information included in the revision history information.

The group classification unit 120 may classify the revision history information into one group or may classify it into a plurality of groups.

The group classification unit 120 can classify a plurality of pieces of revision history information into one group. At this time, the group classification unit 120 can make a classification into groups based on a predetermined condition or any condition, and revision history information regarding a history of successive revisions made by the same user may be classified into one group. Further, the group classification unit 120 may classify revision history information regarding a history of revisions made on the same day into one group. This may enable the old version generation unit 125 described later to generate an old version document that is an old version of the electronic document for each revision step group, facilitating the management and use of electronic documents by the user.

Thus, each group classified by the group classification unit 120 may be a group according to a revision step, and indicate the transition of the version of the history document. That is, unlike the automatic save function performed by an editing application (e.g., the function of saving an electronic file at certain time intervals), the history of a series of revisions in each group may correspond to each version of the history document, and may be a meaningful group in document management by the user.

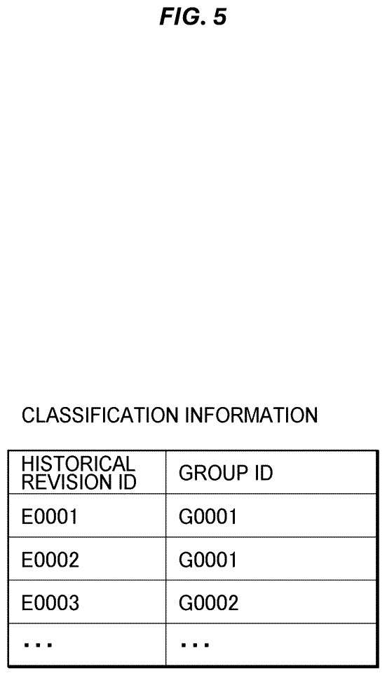

FIG. 5 is a diagram showing an example of classification information stored in the storage unit 110. The classification information stored in the storage unit 110 may include, for example, a historical revision ID and a group ID. The group ID of this embodiment may be information identifying a group into which the revision history information is classified.

The old version generation unit 125 of this embodiment may generate at least one old version document that is an old version of an electronic document (a history document) for each group according to the revision step corresponding to the group based on the electronic document (the history document) and the revision history information, and store old version document information regarding the old version document in the storage unit 110. That is, the old version generation unit 125 may generate at least one old version document, and store the at least one old version document in a memory (e.g., the storage unit 110) in association with version information regarding the document version in the revision step corresponding to the at least one old version document.

Further, the old version generation unit 125 can generate a first old version document according to a first revision step and a second old version document according to a second revision step performed before the first revision step among a plurality of revision steps corresponding to a plurality of groups based on the electronic document (the history document) and the revision history information. Then, the old version generation unit 125 may store the first old version document in a memory in association with first version information regarding the document version in the first revision step, and store the second old version document in the memory in association with second version information regarding the document version in the second revision step.

That is, the old version generation unit 125 can generate a plurality of old version documents according to a plurality of revision steps corresponding to a plurality of groups based on the electronic document (the history document) and the revision history information. Thereby, when the user uploads the history document to the document management system 100, the user can acquire old version documents according to revision steps through the processing by the document management system 100.

Since old version documents are generated by the old version generation unit 125 according to the revision steps, the user can easily manage the transition of the version of the history document.

Note that the old version generation unit 125 may generate an old version document as a document file having the same format (e.g., extension) as the history document, and may generate difference information indicating the differences from the history document (e.g., so to speak, meta information) and treat the history document and the difference information as the old version document. Hereinafter, a description will be given assuming that the old version generation unit 125 generates an old version document as a document file.

For example, the old version generation unit 125 can generate an old version document ID identifying an old version document according to a revision step and include it in the old version document information.

Further, the old version generation unit 125 can include version information regarding the document version in the revision step corresponding to the old version document in the old version document information. This may enable the old version generation unit 125 to associate at least one old version document with the version information.

Here, the version information may be information about the document version in the revision step corresponding to the old version document, and may be, for example, the history document ID of the history document corresponding to the old version document (i.e., the latest version of the document obtained by revising the old version document), or the old version document ID (e.g., the old version document ID of an old version document of an older version than that old version document, or the old version document ID of an old version document of a newer version than that old version document). That is, the version information may be, for example, information indicating which electronic document (e.g., old version document) is revised to the old version document or to which electronic document (e.g., history document or old version document) the old version document is revised.

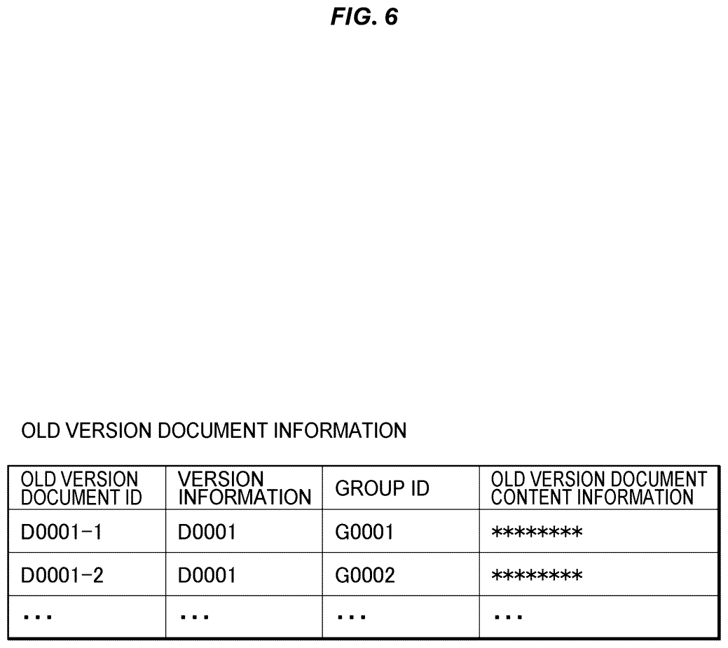

FIG. 6 is a diagram showing an example of old version document information stored in the storage unit 110. The old version document information stored in the storage unit 110 may include, for example, an old version document ID, version information, a group ID, and old version document content information. The old version document content information of this embodiment may be information (e.g., character data) indicating the content of an old version document.

Note that although FIG. 6 shows the history document ID as the version information, the version information may be, for example, the old version document ID.

The output unit 130 of this embodiment may output information for displaying a revision step of at least one old version document to the user terminal 200. Further, the output unit 130 may output information for displaying the revision steps of an electronic document and at least one old version document to the user terminal 200. The output unit 130 can output information for displaying the revision steps based on, for example, the version information.

For example, the output unit 130 can output information for displaying information indicating at least one old version document (e.g., the file names of the old version documents) in order of the revision steps. Further, the output unit 130 can output information for displaying, for example, information indicating an electronic document and information indicating at least one old version document (e.g., the file names of the electronic document and the old version document) in order of the revision steps.

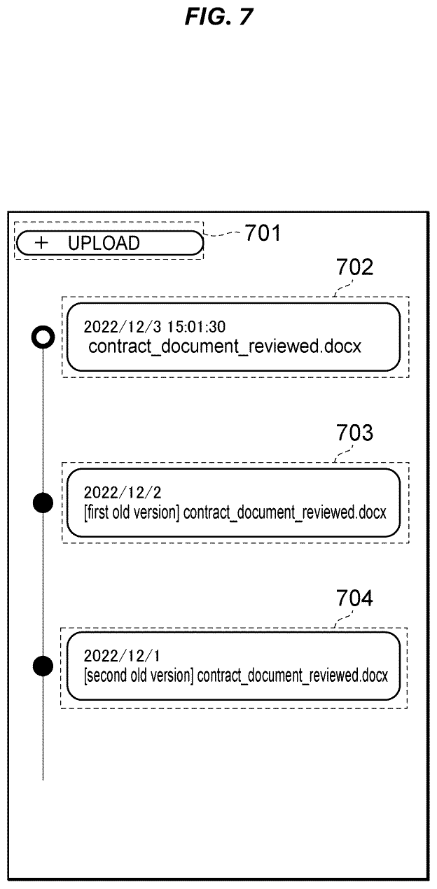

FIG. 7 is a diagram showing an example of revision steps of an electronic document and at least one old version document displayed on the user terminal 200.

The screen shown in FIG. 7 may include a selection area 701 selected by the user when uploading an electronic document, a history document area 702 displaying information indicating a history document uploaded by the user, a first old version document area 703 displaying information indicating a first old version document generated by the old version generation unit 125, and a second old version document area 704 displaying information indicating a second old version document generated by the old version generation unit 125. In the screen shown in FIG. 7, the history document area 702, the first old version document area 703, and the second old version document area 704 are displayed vertically in order of the revision steps. This may enable the user to visually grasp the revision steps.

Further, when the user selects the history document area 702, the first old version document area 703, or the second old version document area 704 through the user terminal 200 (e.g., via a touch operation or a click operation using a mouse), the corresponding document (the history document, the first old version document, or the second old version document) may be displayed. This may enable the user to refer to the document corresponding to the revision step.

Note that the screen displayed on the user terminal 200 using the information output by the output unit 130 is not limited to the screen shown in FIG. 7.

Further, when the user selects the history document area 702, the first old version document area 703, or the second old version document area 704 on the screen shown in FIG. 7, the flow of revisions in the selected history document or old version document may be displayed. That is, when the history document or the old version document has a revision history, the revision history may be displayed. The information output by the output unit 130 may be, for example, information for displaying the content indicated by the revision content information in order of the dates indicated by the revision date information based on the revision history information stored in the storage unit 110.

Subsequently, details of the revision proposal system 10 will be described.

The storage unit 135 of this embodiment may store information processed in the revision proposal system 10. The storage unit 135 can store, for example, target document information, item information, correspondence information, and revision proposal information, which will be described later. The storage unit 135 may be, for example, a memory.

The target document acquisition unit 140 of this embodiment may acquire a target document different from the history document and store target document information regarding the target document in the storage unit 135.

Here, the target document may be an electronic document different from the electronic document (the history document) used for generating an old version document acquired by the history document acquisition unit 115, and may be an electronic document including a target item subject to proposal for revision by the revision proposal unit 165 described later.

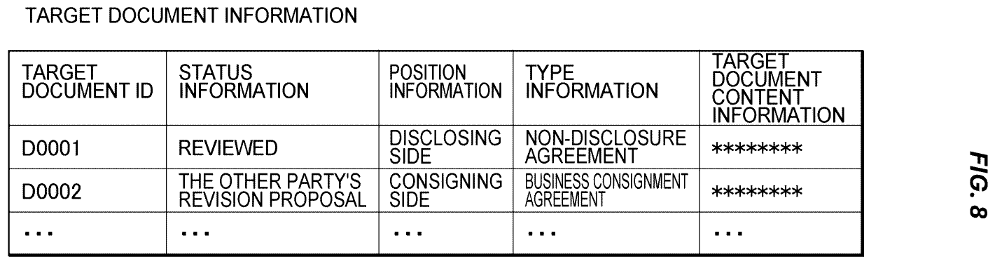

FIG. 8 is a diagram showing an example of target document information stored in the storage unit 135. The target document information stored in the storage unit 135 may include, for example, a target document ID, status information, position information, type information, and target document content information. The target document ID may be information identifying target document information stored in the storage unit 135. The target document content information may be information (e.g., character data) indicating the content of the target document.

The item division unit 145 of this embodiment may divide the content of an electronic document (a history document, an old version document, or a target document) into items included in the electronic document (a history document, an old version document, or a target document), and store item information regarding the items in the storage unit 135.

Here, an item may correspond to an article included in the electronic document. That is, the item division unit 145 can divide the content of the electronic document by, for example, “article”, “paragraph” or “subparagraph”.

The item division unit 145 can, for example, analyze the content of the electronic document to divide the content of the electronic document into items based on the positions of the characters corresponding to the items (e.g., the characters of “article” or “paragraph”). Note that the item division unit 145 may not divide all electronic documents into items, and may not divide all items of an electronic document into items. That is, the item division process performed by the item division unit 145 may be performed on some of the electronic documents and may be performed on a part of an electronic document.

The item division unit 145 can divide an old version document (e.g., a first old version document or a second old version document) into items to generate pre-revision information indicating the content before revision for each item as item information.

The item division unit 145 can divide a history document into items to generate post-revision information indicating the content after revision for each item as item information.

That is, the post-revision information and the pre-revision information of corresponding items have a relationship in which the content indicated by the pre-revision information may be revised by the user to the content indicated by the post-revision information.

Further, the item division unit 145 can divide the target document into items to generate target information indicating the content for each item as item information.

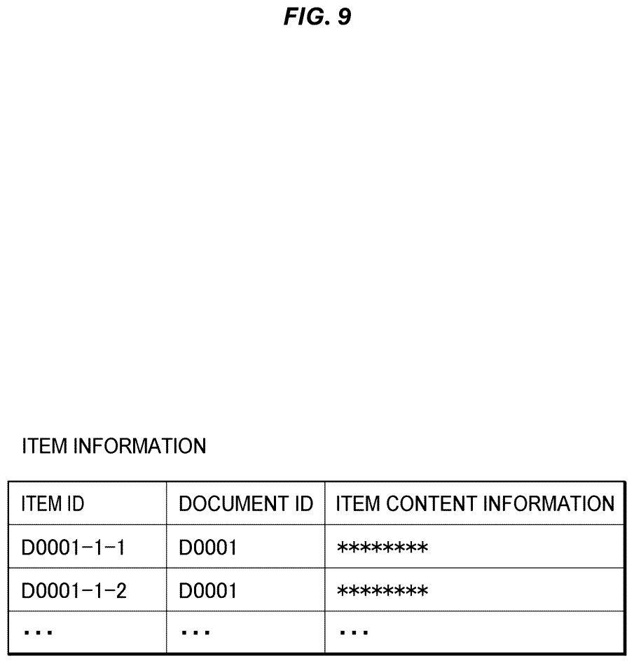

FIG. 9 is a diagram showing an example of item information stored in the storage unit 135. The item information stored in the storage unit 135 may include, for example, an item ID, a document ID, and item content information.

The item ID of this embodiment may be information identifying item information processed in the revision proposal system 10. The document ID of this embodiment may be information indicating an electronic document that includes the content indicated by the item information, and include, for example, a history document ID, an old version document ID, or a target document ID. The item content information of this embodiment may be information indicating the content corresponding to the item, and may be, for example, information indicating the content of each clause.

Note that whether the item information stored in the storage unit 135 is pre-revision information, post-revision information, or target information may be determined based on, for example, the document ID included in the item information (specifically, for example, whether it is a history document ID, an old version document ID, or a target document ID).

The correspondence setting unit 150 of this embodiment may store pre-revision information indicating the content of items of at least one old version document and post-revision information obtained by revising the pre-revision information and indicating the content of the items of the electronic document (the history document) in a memory in association with each other according to the revision step. The correspondence setting unit 150 may generate correspondence information in which the pre-revision information and the post-revision information are associated with each other according to the revision step, and store it in the storage unit 135.

The correspondence information of this embodiment may be information in which the content before revision and the content after revision are associated with each other for each item of the history document and the old version document.

Note that both the item corresponding to the pre-revision information and the item corresponding to the post-revision information may have the same item ID (in other words, for example, the article number or the article and paragraph numbers). Specifically, when both the pre-revision information and the post-revision information correspond to “Article 1” in the electronic document, the revision proposal system 10 may determine that the pre-revision information and the post-revision information are pre-revision information and post-revision information corresponding to each other.

The item corresponding to the pre-revision information and the item corresponding to the post-revision information may have different item IDs. In this case, the revision proposal system 10 may determine that the pre-revision information and the post-revision information are pre-revision information and post-revision information corresponding to each other based on, for example, the contents indicated by the pre-revision information and the post-revision information.

Specifically, when the content indicated by the pre-revision information and the content indicated by the post-revision information are both related to the scope of responsibility of a contracting party, both of them may correspond to the same item, regardless of whether their item IDs are the same or different. On the other hand, when the content indicated by the pre-revision information indicates the expiration date of the contract and the content indicated by the post-revision information indicates the scope of responsibility of a contracting party, both of them may not correspond to the same item, regardless of whether their item IDs are the same or different.

The item ID may be linked to issues that appear in the contract or contract type. For example, it may be linked to issues such as information indicating whether the contract is automatically renewed, governing law, and jurisdiction. For example, when the contract type is a non-disclosure agreement, the item ID may be given in association with issues that appear according to the contract type (e.g., issues such as the scope of confidential information or disposal of confidential information when the contract type is a non-disclosure agreement).

Note that the revision proposal system 10 may determine that the pre-revision information and the post-revision information are pre-revision information and post-revision information corresponding to each other based on both the matching status of the item IDs and the matching status of the contents. At this time, the revision proposal system 10 may place more emphasis on either the matching status of the item IDs or the matching status of the contents based on a predetermined priority.

The order of the item division process performed by the item division unit 145 in the electronic document and the process performed by the correspondence setting unit 150 may not matter. That is, based on the document information, the correspondence setting unit 150 may set the correspondence of the history document and the old version document and then the item division unit 145 may perform the item division process to generate the correspondence information between the pre-revision information and the post-revision information for each item, and after the item division unit 145 performs the item division process, the correspondence setting unit 150 may perform the process of generating correspondence information for each item.

Thus, the item division process performed by the item division unit 145 and the process performed by the correspondence setting unit 150 enable the user to manage the transition of the version of the history document for each item (e.g., “article” or “paragraph”).

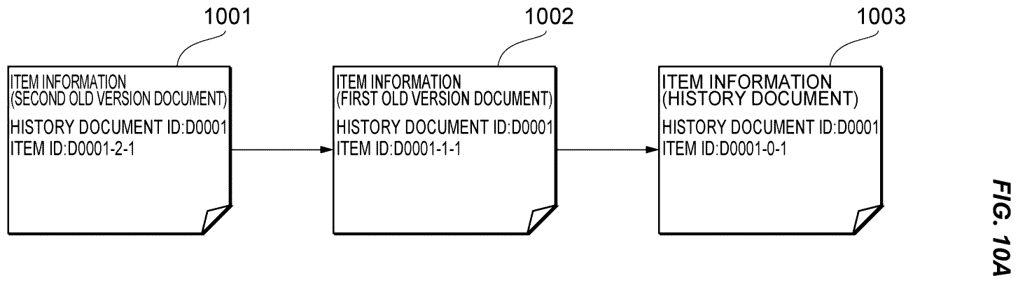

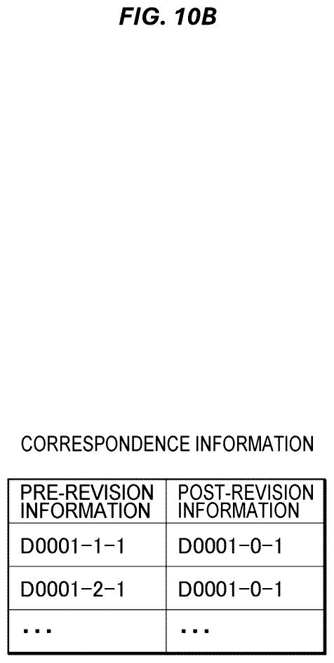

FIG. 10A is a diagram showing an example of revision steps in a history document. Item information 1001 is an example of item information of the second old version document. Item information 1002 is an example of item information of the first old version document. Item information 1003 is an example of item information of the history document. That is, this example is shown that the content indicated by the item information 1001 is revised to the content indicated by the item information 1002, the content indicated by the item information 1002 is further revised to the content indicated by the item information 1003, and thereby the history document is generated.

FIG. 10B is a diagram illustrating an example of correspondence information stored in the storage unit 135. The example of correspondence information shown in FIG. 10B corresponds to the revision steps shown in FIG. 10A. The correspondence information stored in the storage unit 135 may include, for example, pre-revision information and post-revision information. As the pre-revision information and the post-revision information, the correspondence information may include, for example, their corresponding item IDs.

When the revisions shown in FIG. 10A are made, the correspondence information stored in the storage unit 135 may be, for example, as shown in the example of FIG. 10B. That is, for example, the correspondence information may hold the item information 1001 and 1002 as pre-revision information, and the item information 1003 may be held as post-revision information so as to correspond to the item information 1001 and 1002.

Note that the correspondence information may hold the item information 1002 as the post-revision information corresponding to the item information 1001 of the pre-revision information instead of the item information 1003, or may hold both the item information 1002 and the item information 1003. This may enable the revision proposal system 10 to have correspondence information in each revision step.

The correspondence extraction unit 155 of this embodiment may extract at least one piece of correspondence information among the pieces of pre-revision information and the pieces of post-revision information on an item basis in the electronic documents (the history document and the old version document) based on the target information in the target document.

The correspondence extraction unit 155 can extract at least one piece of correspondence information based on the degree of relevance between the pre-revision information and the target information. Specifically, the correspondence extraction unit 155 can extract correspondence information (in particular, for example, post-revision information associated with pre-revision information) corresponding to pre-revision information including an item having a high degree of relevance to the target item indicated by the target information.

Here, the degree of relevance may be, for example, a degree of relevance between the content indicated by the pre-revision information and the content indicated by the target information. Specifically, the degree of relevance may be a degree of relevance based on at least one of, for example, the contents of the pre-revision information and the target information, the position or type in the electronic document corresponding to the pre-revision information and the post-revision information, and issue included in the pre-revision information and target information.

The degree of relevance based on the contents of the pre-revision information and the target information may be, for example, the degree of relevance between the contents of the item (e.g., the contents of the article) indicated by the pre-revision information and the target information. That is, for example, when the content indicated by the pre-revision information is evaluated to be similar to the content indicated by the target information based on a predetermined natural language process, the degree of relevance may be evaluated to be high. This may enable the revision proposal system 10 to extract pre-revision information having content similar to that of the target information, and to perform the revision proposal process without the user revising the content of the target information.

The degree of relevance based on the positions or types in the electronic documents may be evaluated to be high, for example, when the positions or types in the electronic document and the target document are the same. This may enable the revision proposal system 10 to extract pre-revision information of the electronic document in a position or type similar to that of the target document and to perform the revision proposal process.

The issues included in the pre-revision information and the target information may be, for example, matters to be noted in the contents indicated by the pre-revision information and the target information. That is, issues may be, for example, matters that one's own company should particularly confirm in contract documents with the other company, such as the definitions of the terms described or the scope indicated by the content described.

The degree of relevance based on the issues may be evaluated to be high when the issues included in the pre-revision information and the target information are the same or similar. This may enable the revision proposal system 10 to extract pre-revision information having the same or similar issues as those of the target information and to make a revision proposal.

Here, the issues may be set in advance by an administrator of the revision proposal system 10 so as to correspond to predetermined contents. The issues may be set to parts frequently revised by the user based on the correspondence information.

Note that the revision proposal system 10 can extract issues by analyzing the content of a contract document based on a predetermined natural language process.

The degree of relevance may be a degree of relevance based on comment information indicating the contents of comments included in electronic files of the electronic documents (the history document or the old version document).

Here, a comment may be, for example, an annotation in which a user (e.g., a person in charge of the contracting party (i.e., their own company) who uses the revision proposal system 10) writes the intention of or concern about the revision content or the like at the time of inspection of a contract document. Note that a comment may be an annotation written by a person in charge of the other contracting party (e.g., a person in charge of the other company).

The comment information of this embodiment may be information indicating the contents of comments and, for example, may be included in an electronic file of a contract document uploaded by the user. For example, the history document acquisition unit 115 and the target document acquisition unit 140 can acquire comment information when the user uploads an electronic document (a history document or a target document).

The degree of relevance based on the comment information may be evaluated to be high, for example, when the contents of the comments of the pre-revision information and the target information are the same or similar. This may enable the revision proposal system 10 to extract pre-revision information with the same or a similar comment, and to make a revision proposal without the user revising the content of the target information.

Note that items that are prioritized in calculating the degree of relevance between the pre-revision information and the target information may be set by an administrator or user of the revision proposal system 10. That is, for example, when the user configures settings so that the degree of relevance is calculated by prioritizing the position over the content in a contract document, the correspondence extraction unit 155 may be configured not to extract the correspondence information of pre-revision information in which the position is not the same as that in the target information even when the content in the pre-revision information is similar to that in the target information. This may enable the revision proposal system 10 to extract pre-revision information more suitable for revision by the user.

In this way, the correspondence extraction unit 155 can extract correspondence information suitable for a revision proposal to the target item in the target document.

More specifically, the correspondence extraction unit 155 can extract, for example, correspondence information corresponding to pre-revision information related to the target item (i.e., for example, pre-revision information having content similar to that of the target item). In this case, since the content indicated by the target information and the content indicated by the pre-revision information are similar to each other, the content of the revision in the electronic document corresponding to the pre-revision information may also be suitable in the target document corresponding to the target information. Therefore, the correspondence extraction unit 155 can extract correspondence information suitable for a revision proposal to the target item in the target document.

The revision proposal information generation unit 160 of this embodiment may generate revision proposal information regarding proposal of a revision to the target item in the target document based on the post-revision information, and store it in the storage unit 135. More specifically, the revision proposal information generation unit 160 can generate revision proposal information regarding proposal of a revision to the target item in the target document based on the post-revision information included in the extracted at least one piece of correspondence information.

Further, the revision proposal information generation unit 160 may generate revision proposal information based on the post-revision information associated with the pre-revision information that has a high degree of relevance to a target item in the target document.

Here, the revision proposal information may be information for proposing a revision of the target item to the user.

The revision proposal information may include, for example, the post-revision information included in the extracted at least one piece of correspondence information. This may enable the user to grasp past revision contents and then revise the target item.

In addition to the post-revision information, the revision proposal information may further include comment information given by the user in revising the item before revision (i.e., comment information included in the electronic document). This may enable the user to grasp the comments in the past revision steps and then revise the target item.

In addition to the post-revision information, the revision proposal information may include at least one of the position information indicating the position and the type information indicating the type in the electronic document. This may enable the user to grasp the position or the type in the electronic document corresponding to the revision proposal information and then revise the target item.

In addition to the post-revision information, the revision proposal information may further include information on whether or not the revision has been adopted (e.g., status information). Here, whether or not the revision has been adopted may be determined, for example, based on the status information of the history document corresponding to the post-revision information. That is, for example, when the history document is a contract document and the status information of the history document is “concluded”, it may be determined that the revision has been adopted. In addition to the post-revision information, the revision proposal information may include the status information of “concluded”. This may enable the user to grasp whether or not the content after revision indicated by the revision proposal information is content that has been agreed upon, and whether or not it is a revision that is likely to be adopted in the current contract document under inspection as well. Note that when it is unknown whether or not the revision has been adopted, the revision proposal information may or may not include information to the effect that it is unknown whether the revision has been adopted.

The revision proposal information may be prepared or set by others. For example, it may be prepared in advance by a vendor that provides the revision proposal system 10 for use by the user. This may make it possible to reduce the time and effort to set revision proposal information.

The above-mentioned vendor can revise the revision proposal information at any time for reasons such as adaptation to legal revisions. This may enable the user to receive suitable revision proposals in a timely manner.

When it is necessary to modify the revision proposal information due to legal revisions or changes in criteria, a function may be provided to collectively revise revision proposals to a plurality of documents including similar issues. This may enable the user to receive suitable revision proposals.

The revision proposal unit 165 of this embodiment may provide revision proposal information to the user terminal 200. That is, the revision proposal unit 165 may provide revision proposal information regarding proposal of a revision to a target item in the target document that is different from the electronic document (the history document) acquired by the history document acquisition unit 115 based on the post-revision information.

The revision proposal unit 165 can display the results of a series of revision steps corresponding to the extracted correspondence information on the user terminal 200. Specifically, when a plurality of revisions (e.g., the first revision and the second revision) are made in the history document corresponding to the extracted correspondence information, the revision proposal unit 165 can display the result of the revision in the first revision and the result of the revision in the second revision on the user terminal 200. This may enable the user to revise the target item after grasping the detailed steps of the revisions.

The revision proposal unit 165 can provide a plurality of pieces of revision proposal information based on a plurality of pieces of correspondence information to the user terminal 200. In this case, the plurality of pieces of revision proposal information may be associated with information indicating a predetermined order. Note that the predetermined order may be, for example, the order of the date and time when the revision corresponding to the post-revision information was made (e.g., the order of closeness of the date and time when the revision was made), and the order of the status information of the first contract document corresponding to the post-revision information (e.g., the order in which the status information of “concluded” is prioritized).

When providing a plurality of pieces of revision proposal information based on a plurality of pieces of correspondence information to the user terminal 200, the revision proposal unit 165 can collectively display similar pieces of revision proposal information (e.g., revision proposal information having similar content of the post-revision information or the pre-revision information) among the plurality of pieces of revision proposal information.

Specifically, for example, the revision proposal unit 165 can display, on the user terminal 200, one piece of revision proposal information (e.g., revision proposal information based on correspondence information corresponding to the latest post-revision information) among a plurality of pieces of revision proposal information similar to each other, and a button for further displaying other pieces of revision proposal information similar to the one piece of revision proposal information. At this time, the revision proposal unit 165 can further display revision proposal information that is not similar to the plurality of pieces of revision proposal information similar to each other. This may enable the user to simplify the display of similar pieces of revision proposal information and to be provided with more pieces of revision proposal information.

At this time, the revision proposal unit 165 may change the display order according to the number of similar pieces of revision proposal information. That is, as the number of similar pieces of revision proposal information increases, the revision proposal unit 165 may make the display position higher on the screen of the user terminal 200. This may enable the revision proposal system 10 to preferentially provide frequently used sentence examples to the user.

The revision proposal unit 165 may provide revision proposal information based on the post-revision information associated with the pre-revision information that has a high degree of relevance to a target item in the target document. That is, the revision proposal unit 165 may provide the user terminal 200 with revision proposal information that is generated in the revision proposal information generation unit 160 based on the post-revision information associated with the pre-revision information that has a high degree of relevance to a target item in the target document.

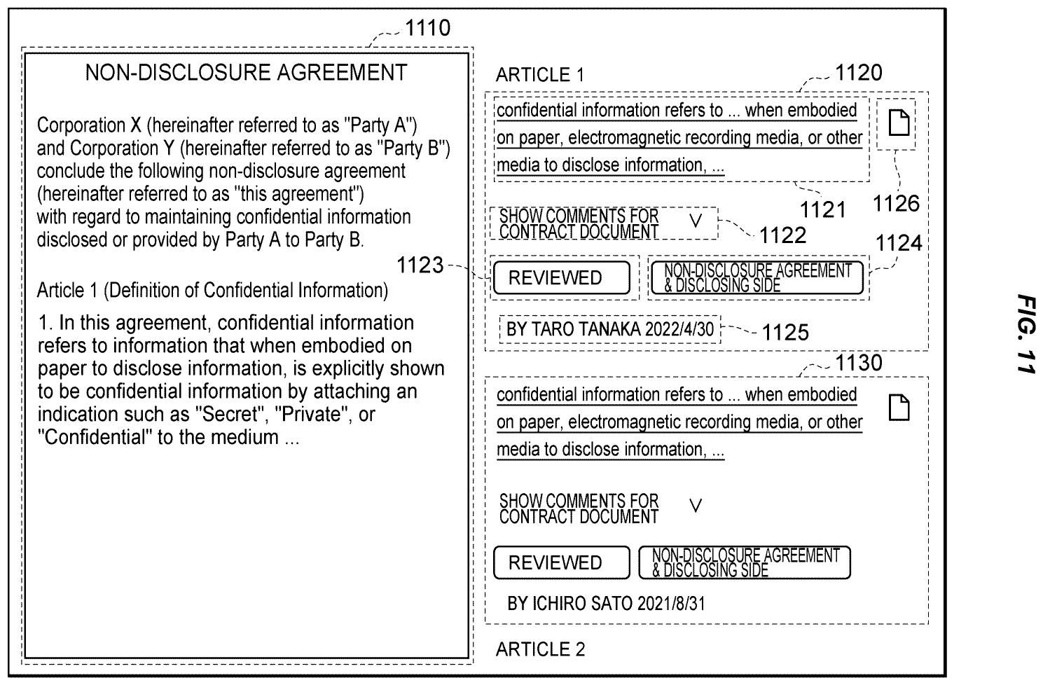

FIG. 11 is a diagram illustrating an example of provision of revision proposal information by the revision proposal unit 165. The screen shown in FIG. 11 shows an example of a display screen of the user terminal 200 on which revision proposal information is provided by the revision proposal unit 165.

The screen shown in FIG. 11 may include at least a target document area 1110 for displaying a target document and a first proposal area 1120 and a second proposal area 1130 for displaying revision proposal information for each item (e.g., article). The first proposal area 1120 may further include a post-revision area 1121 for displaying post-revision information, a first comment button area 1122 showing a button for displaying comment information, a status area 1123 for displaying status information corresponding to the post-revision information, an area 1124 for a type and the like for displaying type information and position information corresponding to the post-revision information, an area 1125 for a revision user name and the like for displaying the name of a revision user who made a revision in a revision step for the history document and its date, and a reference button area 1126 showing a button for referencing the history document. Note that the second proposal area 1130 may include areas corresponding to the areas included in the first proposal area 1120.

In the post-revision area 1121, the content of post-revision information may be displayed as revision proposal information. That is, in the example of the screen shown in FIG. 11, the post-revision information in the correspondence information extracted based on the description content of the target item (here, Article 1 in the target document) may be displayed. The user can revise the target item while referring to the post-revision information displayed in the post-revision area 1121.

Further, the user can revise the target item while referring to the contents displayed in the status area 1123, the area 1124 for a type and the like, and the area 1125 for a revision user name and the like.

That is, for example, when the status information displayed in the status area 1123 is “reviewed”, the user can recognize the revision proposal information displayed in the first proposal area 1120 as, for example, information based on the history document that has been reviewed in their own company.

Further, for example, when the type information and the position information displayed in the area 1124 for a type and the like are the same as the type and position in the target document, the user can recognize the revision proposal information displayed in the first proposal area 1120 as information based on the history document of the same type or position as that of the target document.

For example, when the information indicating the revision user and the date displayed in the area 1125 for a revision user name and the like indicates a reliable person in charge or indicates a date close to the present, the user can recognize the revision proposal information displayed in the first proposal area 1120 as more suitable revision proposal information. That is, for example, the user can grasp whether or not the revision in the history document was made by a reliable revision user or whether or not the revision in the history document was made on a date close to the present, and then determine whether or not to revise the target document based on the revision proposal information.

Thus, information indicating a revision user may be displayed in the area 1125 for a revision user name and the like. In this regard, a revision user for a history document may be different from a person who uploaded the history document to the revision proposal system 10. In such a case, for example, when the person who performed uploading to the revision proposal system 10 generates an old version document by operating an editing application by themself, so to speak, manually, and uploads the old version document to the revision proposal system 10, the “revision user” may be treated as the person who performed uploading in the revision proposal system 10. Therefore, by classifying groups by revision users in the revision proposal system 10 (in particular, the document management system 100) and generating an old version document for each of the groups, the person who made a revision can be correctly displayed on the user terminal 200. This may enable the user to more appropriately determine whether to revise the target document based on the revision proposal information.

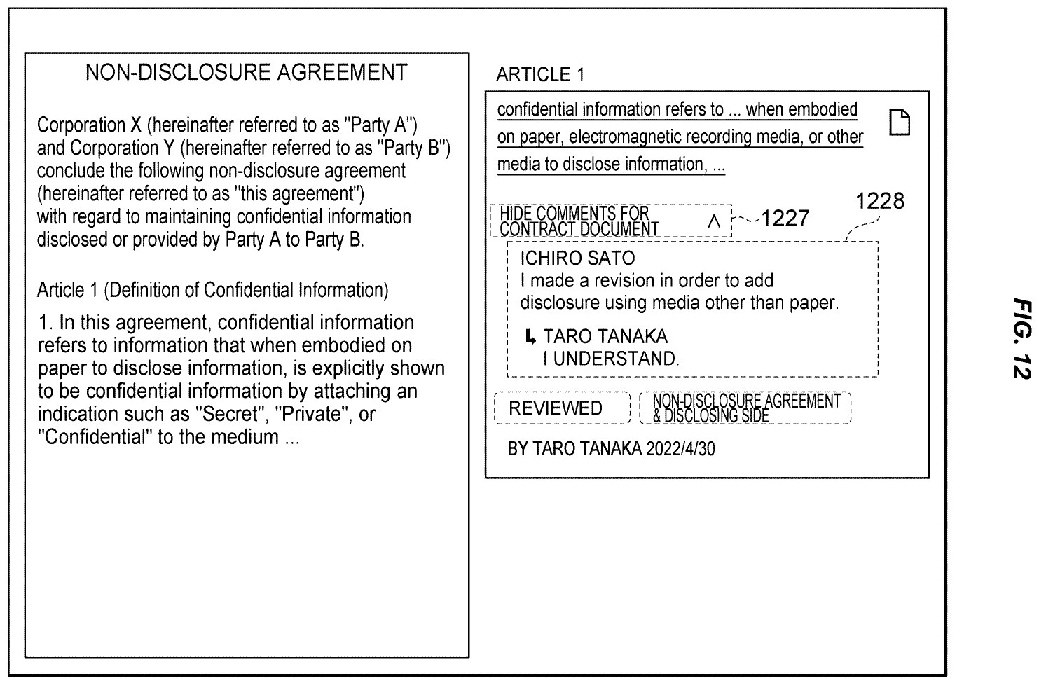

When the first comment button area 1122 is selected, the screen may switch to a screen shown in FIG. 12 described later that displays comment information included in the history document in the extracted correspondence information.

Then, the user can revise the target item while referring to the comment information. That is, for example, the user can grasp the intention of the revision in the history document included in the comment information and then determine whether or not to revise the target document based on the revision proposal information.

When the reference button area 1126 is selected, the history document in the extracted correspondence information may be displayed. The user can revise the target item while referring to the history document. That is, for example, the user can grasp parts of other items of the history document and then determine whether or not to revise the target document based on the revision proposal information.

Note that the displayed history document may be displayed on the user terminal 200 as a window separate from the window displaying the screen shown in FIG. 11.

FIG. 12 is a diagram illustrating an example of provision of revision proposal information by the revision proposal unit 165. The example of the screen shown in FIG. 12 corresponds to FIG. 11, but may show an example of a screen when the first comment button area 1122 in FIG. 11 is selected and comment information is displayed.

The screen shown in FIG. 12 may include a second comment button area 1127 showing a button for hiding comment information in the history document and a comment area 1128 for displaying comment information in the history document.

When the second comment button area 1127 is selected, the screen may switch to the screen shown in FIG. 11 in which the comment information is not displayed. The user can revise the target item while referring to the comment information displayed in the comment area 1128. That is, for example, the user can grasp the intention of the revision in the history document included in the comment information, and then determine whether or not to revise the target document based on the revision proposal information.

The revision proposal unit 165 may display an area for accepting the registration of an evaluation such as a favorite and a flag related to a proposal from users on the user terminal 200. That is, for example, when the proposed revision proposal information is suitable, the user can register the revision proposal information in favorites. When providing revision proposal information to the user terminal 200, the revision proposal unit 165 may further provide information (e.g., a star mark) on whether or not it has been registered in favorites. The revision proposal system 10 may provide the user with a list of revision proposal information registered in favorites. The revision proposal unit 165 may preferentially provide revision proposal information registered in favorites to the user terminal 200. This may enable the revision proposal system 10 to make a revision proposal more suitable for the user. Note that information such as an evaluation or a flag may be used only by an individual user who performed the operation of registering an evaluations or a flag, or may be available to other users, for example, users in the organization to which the user who performed the registration operation belongs. This may make it possible to share information about revision proposals within the organization and provide more suitable revision proposal information. Further, it may be possible to display the original document of the sentence example proposed for revision.

Thus, the revision proposal system 10 according to an embodiment of the present invention may perform the revision proposal process for each item (e.g., clause or issue). This may enable the user to easily perform a revision process of the target document by replacing the item proposed for revision. Specifically, the user can revise the target document by, for example, a simple replacement of the item proposed for revision without performing a revision process that needs to be dealt with by replacement of words (e.g., a revision process that needs to be grammatically dealt with, such as a revision related to syntactic dependency).

This may be because an item (e.g., a clause or an issue) corresponds to a certain range of character strings indicating a certain meaning (e.g., a paragraph, a sentence, or a phrase) instead of a word or character unit, and because the revision proposal information generation unit 160 generates revision proposal information based on post-revision information divided by item.

Note that the revision proposal system 10 according to an embodiment of the present invention may use a word as an item. That is, the revision proposal system 10 may perform the revision proposal process for each word.

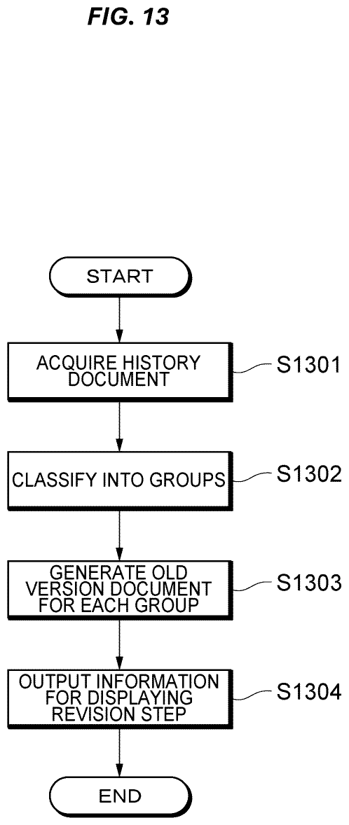

FIG. 13 is a flowchart showing an example of processing in the document management system 100.

First, the history document acquisition unit 115 may acquire a history document (S1301). The group classification unit 120 may classify revision history information into at least one group according to a revision step of the history document (S1302).

The old version generation unit 125 may generate at least one old version document for each group, and store the at least one old version document in a memory in association with version information (S1303). Then, the output unit 130 may output information for displaying the revision step (S1304).

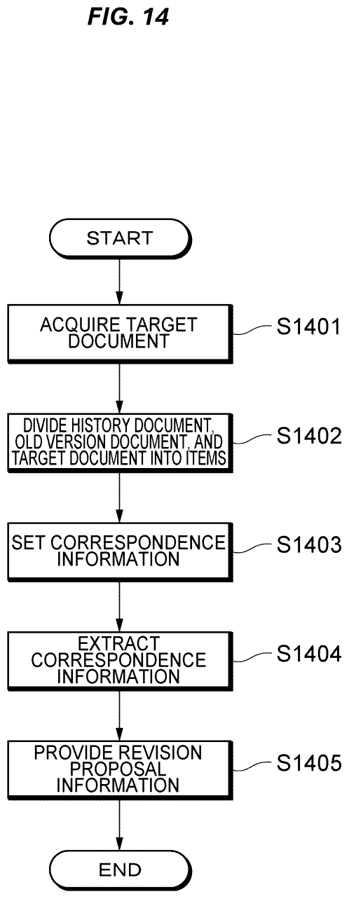

FIG. 14 is a flowchart showing an example of processing in the revision proposal system 10.

First, the target document acquisition unit 140 may acquire a target document (S1401). The item division unit 145 may divide a history document, an old version document, and the target document into items to generate post-revision information, pre-revision information, and target information, respectively (S1402).

The correspondence setting unit 150 may generate correspondence information in which the pre-revision information and the post-revision information are associated with each other according to a revision step (S1403). The correspondence extraction unit 155 may extract at least one piece of correspondence information among pieces of pre-revision information and pieces of post-revision information based on the target information in the target document (S1404).

The revision proposal information generation unit 160 may generate revision proposal information regarding proposal of a revision to a target item in the target document based on the post-revision information included in the extracted at least one piece of correspondence information, and the revision proposal unit 165 may provide the revision proposal information to the user terminal 200 (S1405).

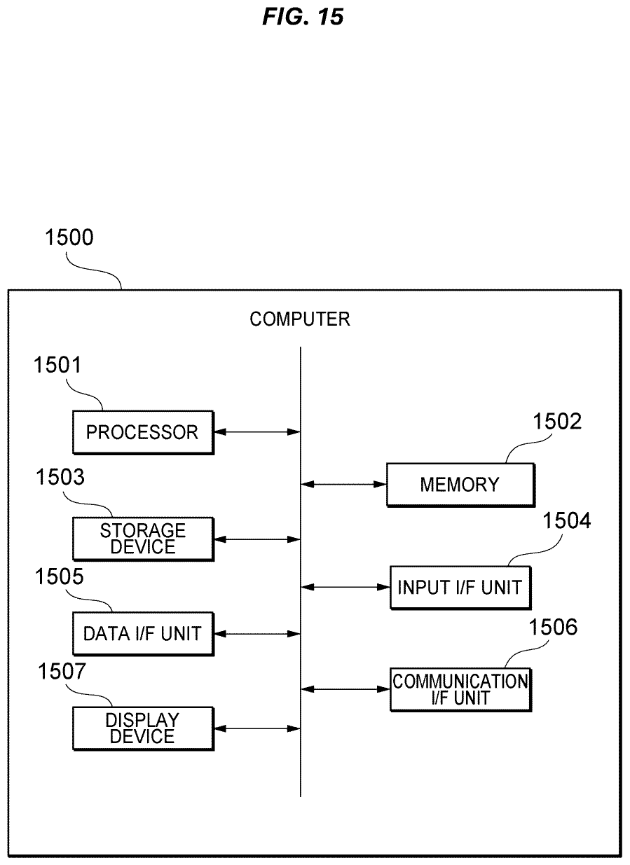

Next, an example of a hardware configuration when the revision proposal system 10 is implemented by a computer 1500 will be described with reference to FIG. 15. FIG. 15 is a diagram illustrating an example of a hardware configuration of the computer 1500.

As shown in FIG. 15, the computer 1500 may include, for example, a processor 1501, a memory 1502, a storage device 1503, an input I/F unit 1504, a data I/F unit 1505, a communication I/F unit 1506, and a display device 1507.

The computer 1500 may be, for example, a server computer, a personal computer (e.g., a desktop, a laptop, and a tablet), a media computer platform (e.g., a cable, a satellite set-top box, and a digital video recorder), a handheld computer device (e.g., a PDA and an e-mail client), other types of computers, or a communication platform.

The processor 1501 may be a control unit that controls various processes in the computer 1500 by executing a program stored in the memory 1502.

The memory 1502 may be, for example, a storage medium such as a RAM (Random Access Memory). The memory 1502 may temporarily store a program code of a program executed by the processor 1501 and data required at the time of executing a program.

The storage device 1503 may be, for example, a non-volatile storage medium such as a hard disk drive (HDD) or a flash memory. The storage device 1503 may store an operating system and various programs for implementing the above configurations.

The input I/F unit 1504 may be a device for receiving input from the user. The input/F unit 1504 may be, for example, a keyboard, a mouse, a touch panel, various sensors, a wearable device, and the like. The input I/F unit 1504 may be connected to the computer 1500 via an interface such as USB (Universal Serial Bus), for example.

The data I/F unit 1505 may be a device for inputting data from outside the computer 1500. The data I/F unit 1505 may be, for example, a drive device for reading data stored in various storage media. The data I/F unit 1505 may be provided outside the computer 1500. When the data I/F unit 1505 is provided outside the computer 1500, the data I/F unit 1505 may be connected to the computer 1500 via an interface such as USB, for example.

The communication I/F unit 1506 may be a device for performing data communication with a device outside the computer 1500 by wire or wireless via a network such as the Internet. The communication I/F unit 1506 may be provided outside the computer 1500. When the communication I/F unit 1506 is provided outside the computer 1500, the communication I/F unit 1506 may be connected to the computer 1500 via an interface such as USB, for example.

The display device 1507 may be a device for displaying various information. The display device 1507 may be, for example, a liquid crystal display, an organic EL (Electro-Luminescence) display, a wearable device display, and the like. The display device 1507 may be provided outside the computer 1500. When the display device 1507 may be provided outside the computer 1500, the display device 1507 is connected to the computer 1500 via a display cable or the like, for example. When a touch panel is adopted as the input I/F unit 1504, the display device 1507 may be configured integrally with the input I/F unit 1504.

As described above, an embodiment of the present invention has been described. The document management system 100 can acquire an electronic document including revision history information, generate an old version document according to a revision step corresponding to a revision history based on the electronic document and the revision history information, and store the old version document in a memory in association with version information regarding the document version in the revision step corresponding to the old version document. This may enable the document management system 100 to perform document management in an electronic document including a revision history.

Further, the document management system 100 can classify the revision history information into groups corresponding to revision steps, and generate an old version document for each group. This may enable the document management system 100 to perform document management in an electronic document including a revision history based on the groups corresponding to the revision steps.

Further, the document management system 100 can classify revision history information including at least one of revision user information and revision date information based on at least one of the revision user information and the revision date information. This may enable the user to manage the electronic document and the old version document in units of revision steps that are easy for the user to manage.

Further, the document management system 100 can classify the revision history information into a plurality of groups, generate a first old version document and a second old version document based on the electronic document and the revision history information, store the first old version document in a memory in association with first version information, and store the second old version document in the memory in association with second version information. This may enable the user to manage an electronic document that has undergone a plurality of revision steps by dividing it into versions according to the revision steps.

Further, the document management system 100 can output information for displaying the revision steps of the old version documents to the user terminal 200. This may enable the user to grasp the revision steps of the old version documents.

Further, the revision proposal system 10 can provide revision proposal information regarding proposal of a revision to a target item in a target document based on post-revision information that indicates content of an item of an electronic document including revision history information and that is stored in a memory in association with pre-revision information of an old version document generated based on the revision history information according to a revision step in which the pre-revision information is revised. This may enable the revision proposal system 10 to propose revisions in an electronic document including a revision history.

The revision proposal system 10 can provide revision proposal information based on the post-revision information associated with the pre-revision information that has a high degree of relevance to a target item in the target document. This may enable the user to receive a revision proposal based on the post-revision information related to the target item.

The revision proposal system 10 can provide revision proposal information including the post-revision information. This may enable the user to receive a revision proposal based on a past revision result.

Note that the present embodiments are for facilitating understanding of the present invention, and are not for interpreting the present invention in a limited way. The present invention may be modified/improved without departing from the spirit thereof, and the present invention includes equivalents thereof.

As used in the present invention, a “unit” does not simply mean physical means, but cases where the functions of the “unit” are implemented by software are included. The functions of one “unit” or apparatus may be implemented by two or more physical means, apparatuses, or pieces of software, or the functions of two or more “units” or apparatuses may be implemented by one physical means, apparatus, or piece of software.

What is claimed is:

1. A document management method executed by a processor, the document management method comprising:
acquiring an electronic document including revision history information regarding a revision history;
generating at least one old version document that is an old version of the electronic document according to a revision step corresponding to the revision history based on the electronic document and the revision history information; and
storing the at least one old version document in a memory in association with version information regarding a document version in the revision step corresponding to the at least one old version document.

2. The document management method according to claim 1, further comprising
classifying the revision history information into at least one group corresponding to the revision step, wherein
generating the at least one old version document comprises generating, for each of the at least one group, the at least one old version document according to the revision step corresponding to the at least one group.

3. The document management method according to claim 2, wherein
the revision history information includes at least one of revision user information indicating a user who makes a revision and revision date information indicating a date on which a revision is made, and
classifying into the at least one group comprises classifying the revision history information into at least one group corresponding to a revision step based on at least one of the revision user information and the revision date information included in the revision history information.

4. The document management method according to claim 2, wherein
classifying into the at least one group comprises classifying the revision history information into a plurality of groups corresponding to revision steps,
generating the at least one old version document comprises generating a first old version document according to a first revision step and generating a second old version document according to a second revision step performed before the first revision step, among a plurality of revision steps corresponding to the plurality of groups based on the electronic document and the revision history information, and
storing in the memory comprises storing the first old version document in a memory in association with first version information regarding a document version in the first revision step, and storing the second old version document in a memory in association with second version information regarding a document version in the second revision step.

5. The document management method according to any one of claim 1, further comprising outputting information for displaying a revision step of the at least one old version document to a user terminal.

6. A document management system comprising at least one processor, wherein
the at least one processor is configured to:
acquire an electronic document including revision history information regarding a revision history;
generate at least one old version document that is an old version of the electronic document according to a revision step corresponding to the revision history based on the electronic document and the revision history information; and
store the at least one old version document in a memory in association with version information regarding a document version in the revision step corresponding to the at least one old version document.

7. A non-transitory computer-readable medium storing a document management program for causing a processor to:
acquire an electronic document including revision history information regarding a revision history;
generate at least one old version document that is an old version of the electronic document according to a revision step corresponding to the revision history based on the electronic document and the revision history information; and
store the at least one old version document in a memory in association with version information regarding a document version in the revision step corresponding to the at least one old version document.

8. A revision proposal method executed by a processor, the revision proposal method comprising
based on post-revision information that indicates content of an item of an electronic document including revision history information regarding a revision history and is stored in a memory in association with pre-revision information indicating content of an item of at least one old version document that is an old version of the electronic document generated based on the revision history information according to a revision step in which the pre-revision information is revised, providing revision proposal information regarding proposal of a revision to a target item in a target document different from the electronic document.

9. The revision proposal method according to claim 8, wherein
providing the revision proposal information comprises providing the revision proposal information based on the post-revision information associated with pre-revision information that has a high degree of relevance to a target item in the target document.

10. The revision proposal method according to claim 8, wherein the revision proposal information includes the post-revision information.

11. A revision proposal system comprising at least one processor, wherein
the at least one processor is configured to:
store post-revision information indicating content of an item of an electronic document including revision history information regarding a revision history in a memory in association with pre-revision information indicating content of an item of at least one old version document that is an old version of the electronic document generated based on the revision history information according to a revision step in which the pre-revision information is revised; and
provide revision proposal information regarding proposal of a revision to a target item in a target document different from the electronic document based on the post-revision information.

12. A non-transitory computer-readable medium storing a revision proposal program for causing a processor to:
store post-revision information indicating content of an item of an electronic document including revision history information regarding a revision history in a memory in association with pre-revision information indicating content of an item of at least one old version document that is an old version of the electronic document generated based on the revision history information according to a revision step in which the pre-revision information is revised; and
provide revision proposal information regarding proposal of a revision to a target item in a target document different from the electronic document based on the post-revision information.
